(19) United States
(12) Patent Application Publication
(10) Pub. No.: US 2013/0105394 A1
(43) Pub. Date: May 2, 2013

(54) STATIC PRESSURE DESALINATION ASSEMBLY

(71) Applicant: Garry R. Whyte, Aurora, OR (US)

(72) Inventor: Garry R. Whyte, Aurora, OR (US)

(21) Appl. No.: 13/663,182

(22) Filed: Oct. 29, 2012

Related U.S. Application Data
(60) Provisional application No. 61/552,319, filed on Oct. 27, 2011.

(51) Int. Cl. B01D 61/08; C02F 1/44; C02F 103/08

(52) U.S. Cl. 210/652; 210/321.6; 210/242.1

(57) ABSTRACT

A desalination device that uses the natural and constant static pressure of the ocean depths to cause seawater to push against a reverse osmosis membrane with sufficient force to separate the molecules of water and salt. The resulting water, the permeate, is pumped to the surface using normal subsurface pumps.

### CROSS-REFERENCE TO RELATED APPLICATIONS

This application claims the benefit of provisional application 61/552,319.

### BACKGROUND

Freshwater remains one of the earth's most valuable resources. Seawater, comprising over 95% of the earth's water supply, cannot be used for many freshwater applications without removal of salt and other chemicals. Desalination has been practiced since ancient times. Today, a number of technologies are used, including heat distillation, ion extraction via ion exchange or electrodialysis, freezing desalination, reverse osmosis, solar humidification, and even iceberg towing.

Seawater is often separated by pressurizing reverse osmosis membranes (ROMs). These ROMs need high pressure to induce the water molecules to cross the membrane barrier leaving the larger salt molecules behind. The high pressure is typically generated by powerful pumps that require large energy inputs. In addition, when the process is complete, salty effluent is generated which must be discharged at some distance from plant intakes and which can have an negative impact on the local marine environment.

### SUMMARY

A desalination device comprising a pressure vessel, at least one ROM, and a pump is disclosed. This device may be used to desalinate seawater by lowering it to a suitable depth in a body of water, and evacuating the interior of the pressure vessel until the pressure differential between the interior and the exterior is great enough to cause reverse osmosis to occur. The pump can then return the salt-free permeate to the surface.

As another aspect, a buoyant element may be used to retain the pressure vessel at a position at a depth controlled by a tether connected with the pressure vessel.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a view of a buoyant pressure vessel with a ROM canister showing a pretreatment section and a desalinization section of the ROM canister.

FIG. 2 is sectional view of the interior hull of pressure vessel with one tier of ROM canisters.

FIG. 3 is a sectional view of the interior hull of pressure vessel with the cap removed and the ROM canisters in an aligned configuration.

FIG. 4 is a sectional view of the interior hull of pressure vessel with the cap removed and the ROM canisters in a staggered configuration.

FIG. 5 is a sectional view of a double-hulled pressure vessel with the exterior cap removed.

FIG. 6 is a perspective view of the pressure vessel with an alternate anchor which acts as a pump, and showing the interior hull.

FIG. 7 is a perspective view of an anchored and capped pressure vessel with a plurality of reverse osmosis canisters.

FIG. 8 is perspective view of an alternative embodiment utilizing ROM across a buoyant bulb.

FIG. 9 is a perspective view of an alternative embodiment utilizing ROM canisters in a vertical configuration.

FIG. 10 is a perspective view of a barge for transporting the pressure vessel with installed ROM canisters.

FIG. 11 is a perspective view of a barge during ascent or descent of the pressure vessel with installed ROM canisters.

### DETAILED DESCRIPTION OF PREFERRED EMBODIMENTS

Reverse osmosis is a well known method of removing impurities, such as salt, from water. It is accomplished with special ROMs made with pores that permit water molecules to pass, but block salt. Typical ROMs require about 850 psi to cause fresh water (“permeate”) to pass through while leaving salt behind in the “concentrate”. Only a limited percentage of the water in a given input can be forced through the ROM before the salt concentration rises too high for efficient desalination. The concentrate is then discharged from the apparatus. When this process is conducted at sea level, all of the water must be pressurized mechanically by pumps, while only a fraction of it will become fresh water. Additionally, the concentrate is often discharged into biologically rich shoreline areas.

If, instead of using pumps at sea level, a desalination apparatus is lowered deep below the ocean's surface and a portion of it evacuated, the static pressure of the ocean itself will drive the reverse osmosis process. This method requires that the permeate (the fresh water that emerges from the ROMs) be pumped to the surface, which requires a powerful pump capable of delivering as much pressure as the ocean is exerting. Because the pump need only pressurize the permeate, rather than both permeate and concentrate, there is substantial energy savings as the concentrate is never run through any pump. In addition, salty concentrate is discharged at the bottom of the ocean rather than in sensitive littoral environments.

In a preferred embodiment, the desalination device comprises a large pressure vessel in the form of an elongate hollow tube with domed ends. This tube must be capable of withstanding the pressures at depth without crushing or developing leaks. Attached through the exterior of the pressure vessel are reverse-osmosis canisters, which are commercially available and have a large surface area of membrane packed into a small volume. Suitable ROM canisters include those in the Koch Fluid Systems TFC RO Series®.

When the device is first lowered into the water, some amount of water will flow into the interior of the pressure vessel. This process will cause the pressure in the interior to match the exterior water pressure as it is lowered. A pump within the pressure vessel can then be employed to push the accumulated water outwards causing a pressure differential to be formed between the inner chamber and the ocean's static pressure. When this is sufficient to cause the seawater to be separated by the ROM and the accumulated seawater will be replaced by salt-free permeate that can be sent to the surface or to land. In steady-state operation, the pump operates continuously, maintaining the interior of the pressure vessel at a pressure considerably lower than that of the surrounding sea water at that depth, for example about 1 atmosphere of pressure, and permeate enters continuously from the canisters.

Static pressure in the device is maintained by pneumatic and hydrostatic control. The ROMs need a sufficient pressure differential, at least equal to the osmotic pressure of the fluid. Although the differential varies with the choice of filter, in one embodiment, the required differential will be approximately 850 psi. The devices “pushes” the water using the ocean static pressure working against the exterior ROM surface. The other side of the ROM is exposed to a chamber that has a 1 atm. pressure. This 1 atm. pressure can be maintained by evacuating the water from the interior of the pressure vessel as it accumulates from the ROM flow (hydrostatic, variable speed pumping).

Preferably, the device has positive buoyancy when placed in water both under normal operating conditions and when reverse osmosis has stopped due to increased pressure within the pressure vessel. This buoyancy makes the device convenient to service, because it can be summoned to the surface for maintenance or repair on a simple barge rather than a heavy-lift ship or by deep diving humans or machines. The device requires an anchor and a tether to secure it in place. A winch may be provided to pull the device down from the surface. Preferably, both the winch and the pump are located within the pressure vessel or attached to it, so that they, too, may be conveniently serviced if necessary by simply permitting the device to float up to the surface.

Both power and a hose or pipe for conveying permeate to the place where it may be used must be provided. Preferably, in one embodiment the anchor may comprise a socket that may receive a mating portion at the bottom of the pressure vessel when it is pulled down by the winch and provides both a sealed connection to a pipe and a power connection to operate the pump. A battery may be charged from this connection to accumulate power to operate the winch when the device is disconnected from the socket. When the device is constructed as described, there are no active or moving parts on the anchor, but merely a socket, a securement point for the tether, and non-moving connections for water and power. Thus all moving parts can be serviced at sea level rather than deep below the ocean. However, it is also possible to put pump and winch in the anchor.

The device is tethered to an anchor but may be otherwise free floating. In one embodiment, it can move with currents within defined limits. The device is shock-resistant and sabotage-resistant. The operating depth is largely independent of seafloor depth, and the desalination device can be located almost anywhere with minimal site accommodations. Siting the device in one embodiment may be accomplished by having the device tethered on Spectra® or other suitably strong industrial line to an anchor. The anchor is insensitive to bottom conditions or depth, so the device can be placed almost anywhere there is sufficient overall depth.

In a preferred embodiment, using ROM cartridges, the total area of the pressurized ROM can be quite large without requiring larger chambers or additional energy inputs other than a corresponding increase in delivery pump capacity. This is because the static pressure is freely available at the operational depths no matter how large the area of the ROM. Since there is little restriction on size at the operational depths, scaling up the device yields the better economies of scale that are unavailable with mechanically pressurized systems.

The delivery pipe pressure can be handled by any one of many existing well water pumps that are designed to carry water upwards from depths even greater than the present invention requires. These are commonly used for irrigation projects and are inexpensive. The water can be delivered by flexible pipe similar to that used by natural gas utilities to distribute high pressure methane.

A constant flow across the ROM is maintained by evacuating the accumulating water inside the pressure vessel, maintaining a constant pressure differential between the airspace inside and the seawater outside the device. The pressure within the interior of the pressure vessel must be kept low enough to permit proper operation. In practice, pressure can be governed by a water level sensor, which is more robust and less prone to failure than a pressure sensor.

Preferably, the device operates in the mesopelagic zone of the world's oceans, which is the region between 200-1,000 m. There is very little light or biological activity in open water at these depths. It is unlikely that the ROMs will be clogged by free floating algae or other growing organisms and using the recently developed porous coverings for ROMs will extend the periods of productivity between cleanings. In addition, concentrate will be dispersed in relatively lifeless areas and mix well with the surrounding seawater before it ever encounters life which might be affected by enhanced salinity.

The device can be used anywhere with appropriate depth, for a variety of products and services, including oilfield needs; freshwater for drinking, agriculture, or cooling; metals separation.

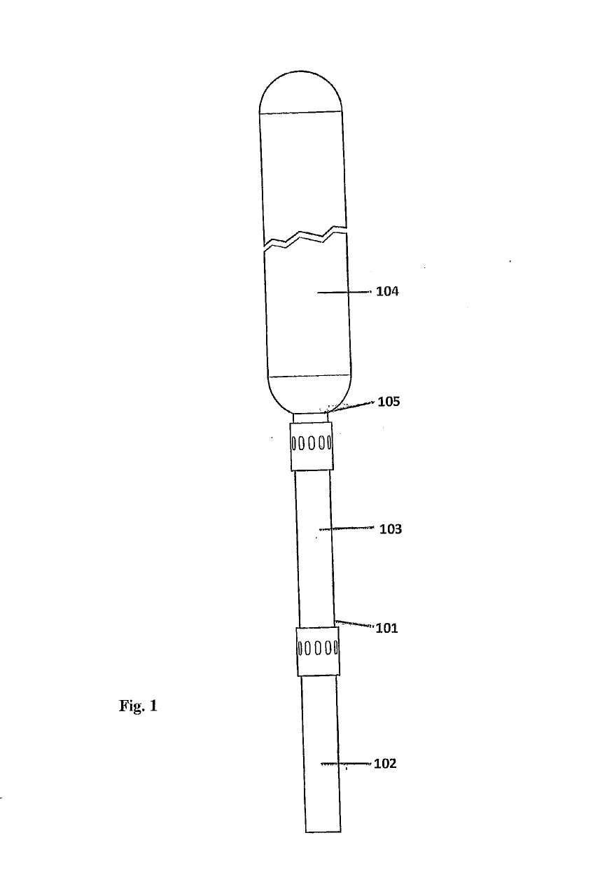

FIG. 1 shows a ROM canister 101 with a pretreatment section 102 and desalination section 103 in series. These sections are connected to sealed pressure vessel 104 which can collect the permeate emerging from the output 105 of canister 101. The canister 101 contains a membrane 106 (not shown) coiled so as to maximize surface area.

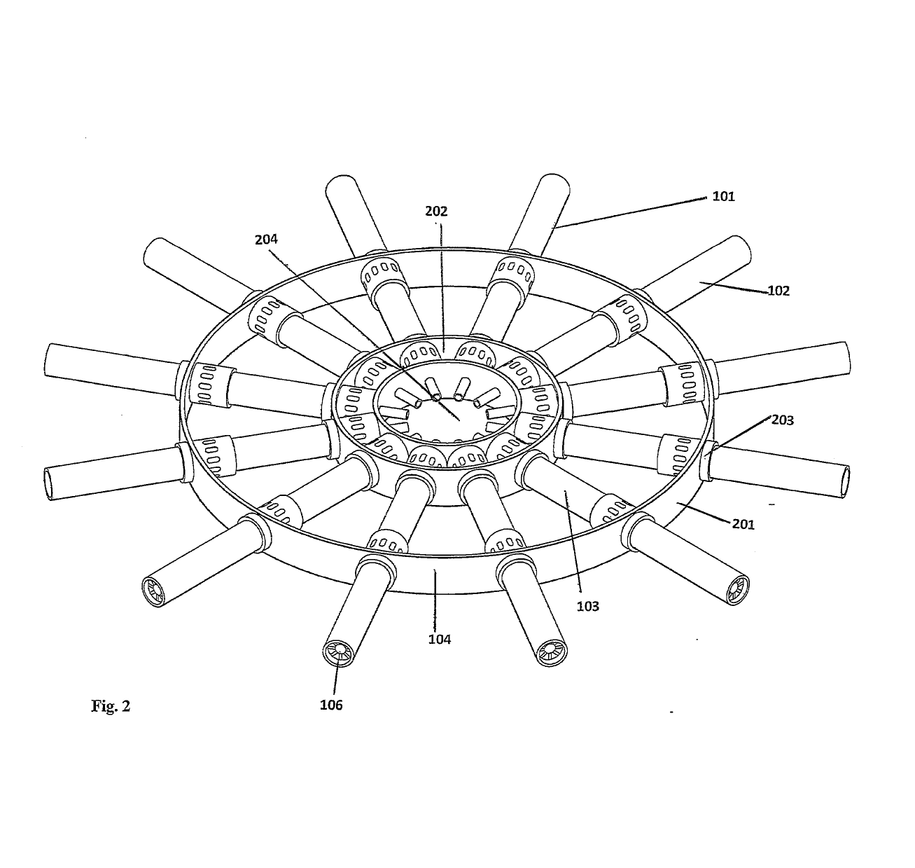

FIG. 2 shows a sectional view of a tier of ROMs canisters 101. This embodiment shows a pressure vessel 104 with an outer higher pressure hull 201 surrounding an inner lower pressure hull 202. The concentric arrangement of outer hull 201 and inner hull 202 helps the device withstand external pressure. The apertures 203 in the hulls 201 and 202 provide some structural support in addition to sealing the interface between the hulls 201 and 202 and ROM canisters 101. Water enters canister 101, passing thru membrane 106, and then permeate gathers in the permeate collection section 204.

As shown in this embodiment, the ROM elements include a pretreatment section 102 in series with a desalinization section 103. The inner conduit for permeate is at about 1 atm., whereas the seawater is at about 71 atm., resulting in a pressure after the pretreatment section at about 64 atm and pressure after the desalinization section at about 58 atm.

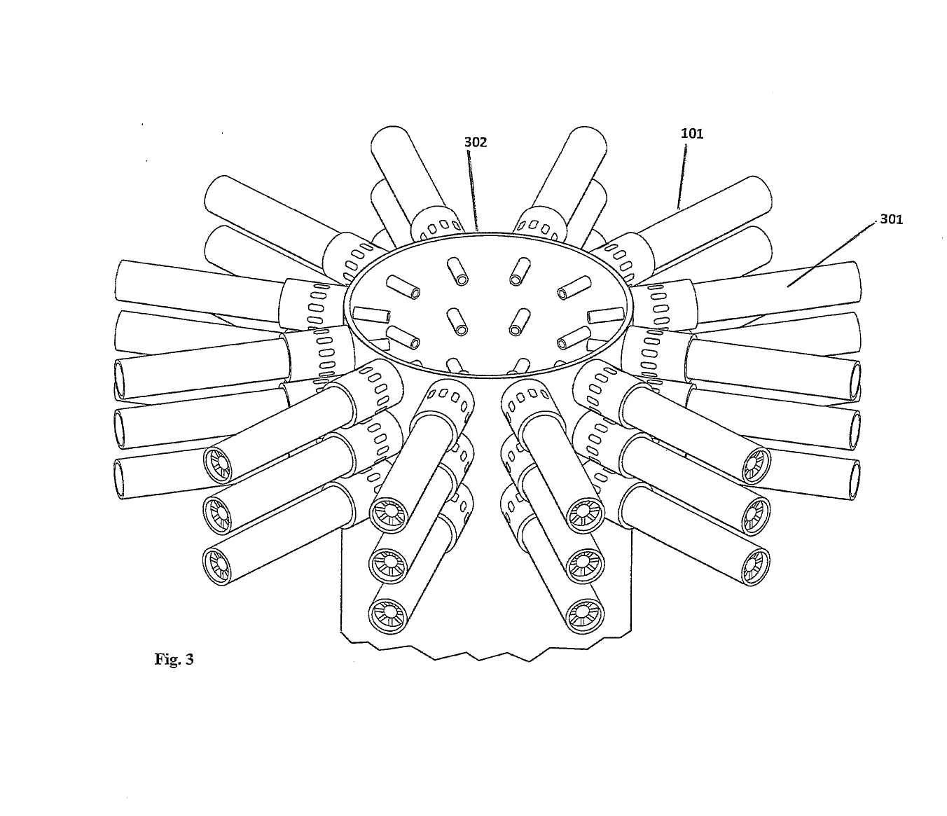

FIG. 3 shows a plurality of ROM canisters 101 with desalinization section 301, although those skilled in the art will recognize that any of a plethora of ROM elements would work with this device. The aligned configuration of the ROM canisters here is for ease of siting this device with a rolling mechanism (not shown). This embodiment has a single hull 302.

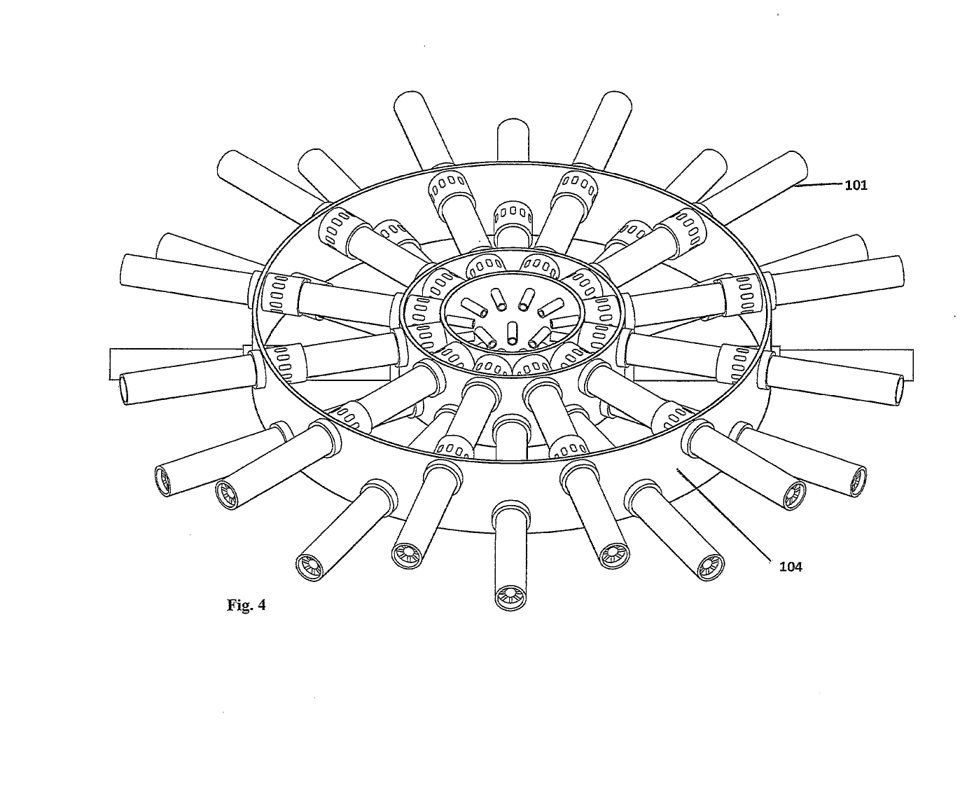

FIG. 4 shows a plurality of ROM canisters 101, in a staggered configuration. This configuration allows for a more densely packed pressure vessel 104. In this embodiment, outer hull 201 and inner hull 202 are shown with canisters 101 including pretreatment sections 102 and desalinization sections 103.

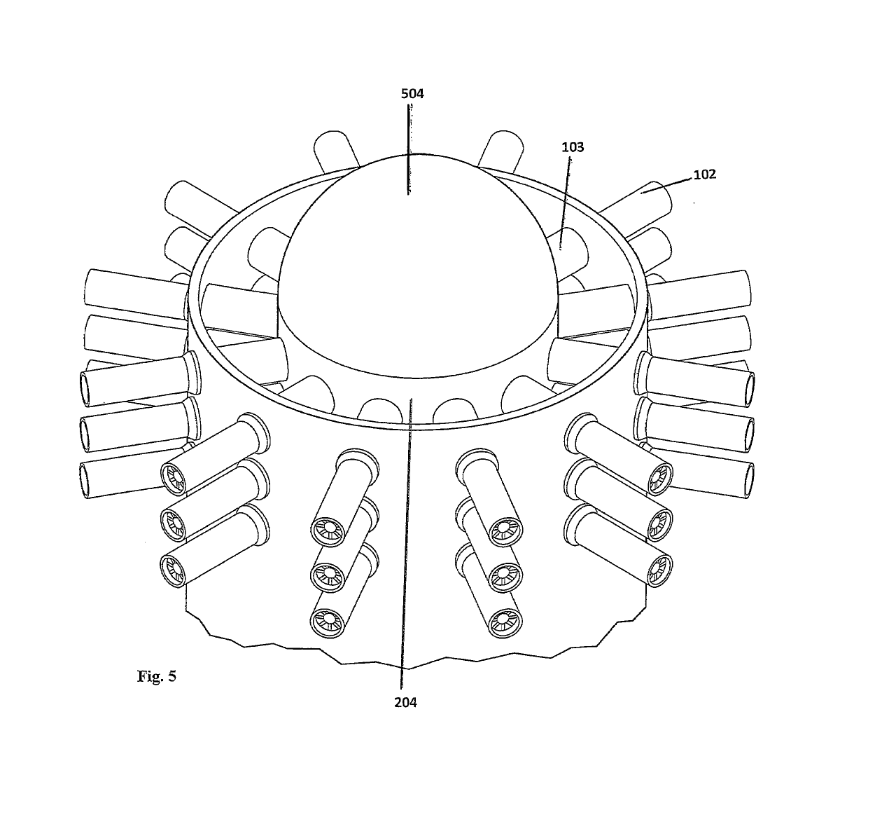

FIG. 5 shows a plurality of ROM canisters with both desalinization sections 103 and pretreatment sections 102, and further showing the cap 504 on the permeate collection section 204.

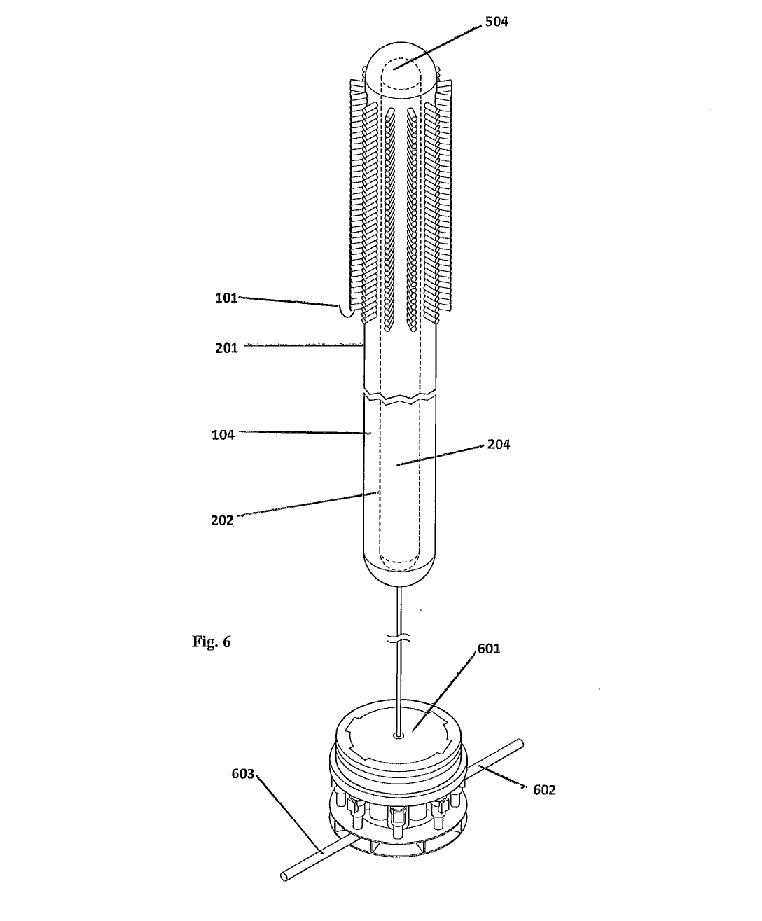

FIG. 6 shows pressure vessel 104 with an outer higher pressure hull 201 surrounding an inner lower pressure hull 202, with ROM canisters 101 installed. The pressure vessel 104 is connected to a pump 601 which also serves to anchor the vessel. Pump 601 has a permeate line 602 to pump permeate to a destination and concentrate line 603 to discharge concentrate. Cap 504 on the permeate collection section 204 assists with buoyancy of the device

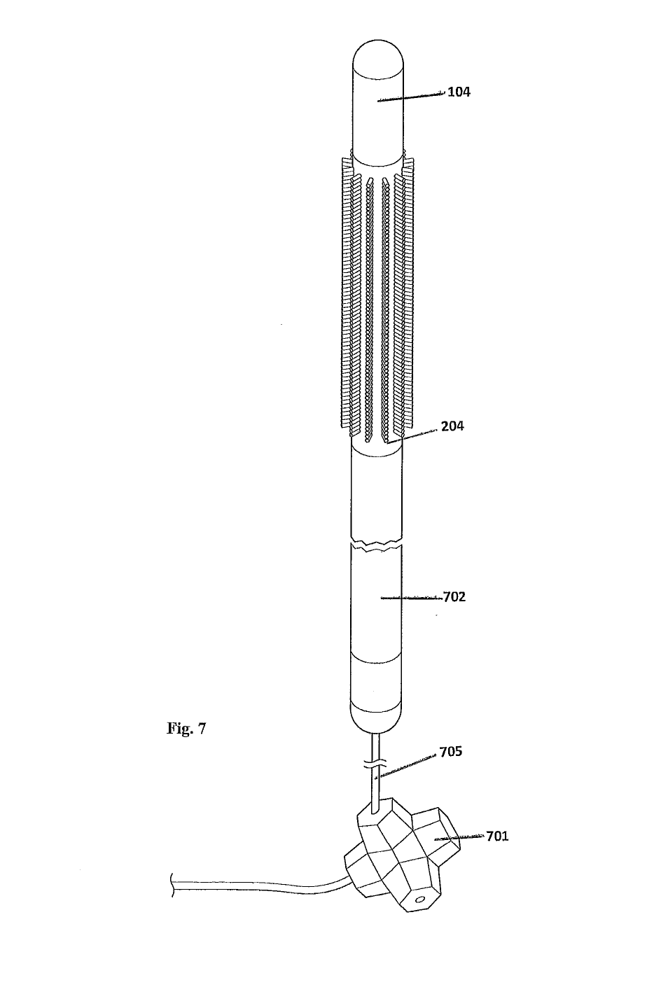

FIG. 7 shows an alternate embodiment where the pressure vessel 104 is anchored to a simple weight 701. In practice, this FIG. 7 embodiment may produce 5 million permeate gallons per day when located at a water depth of approximately 2000 feet. The permeate capture section 204 is approximately 1.5 meters in diameter and 65 meters in length. Housing 702 contains a pump 703 (not shown) and winch 704 (not shown), which are conventional. Winch 704 holds Spectra® line or similarly strong industrial line to control the periodic ascent to the ocean surface for maintenance and repair. Umbilical cord 705 is a bundled electrical conductor to power pump 703 and winch 704, a communications line for sensor signals to and from a control site (not shown), and permeate line.

Housing 702 encloses pump 703 in the buoyant environment of pressure vessel 104, which permits pump 703 to be one of a wide variety of pumps which are capable of operating at approximately 1 atm. This location also permits ease of surfacing the pump along with other components associated with the pressure vessel for maintenance or repair.

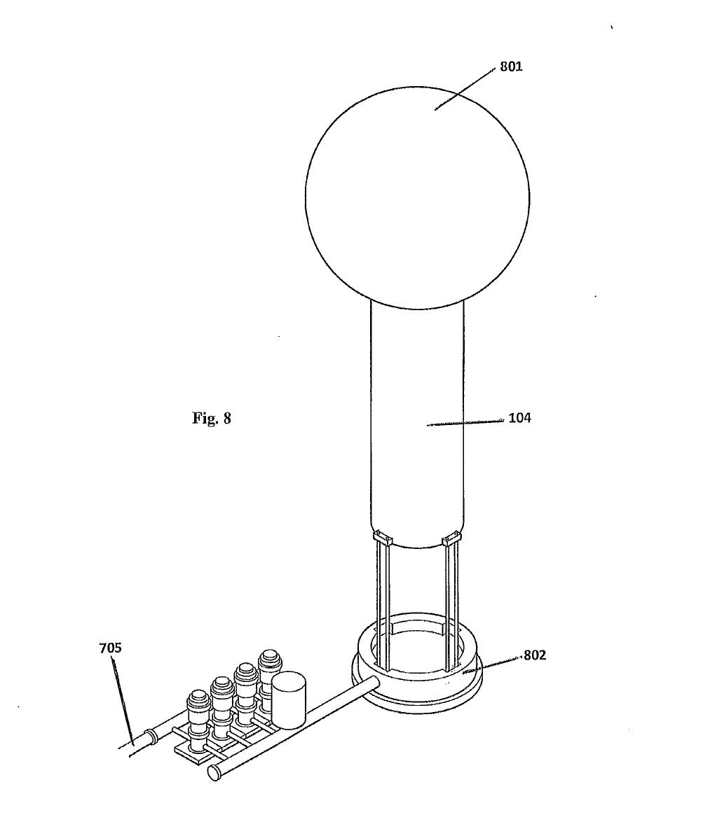

FIG. 8 shows an alternate embodiment where pressure vessel 104 is attached to umbilical cord 705. Pressure vessel 104 has a buoyant bulb 801 which is covered with one or a plurality of ROMs. Water passes through bulb 801 surface, emerging as permeate to the bulb 801 interior, passing through vessel 104 into umbilical cord 705. Here, pressure vessel 104 is anchored to an anchoring socket 802 that both seals vessel 104 and provides pumping action for the delivery of water from vessel 104 through umbilical cord 705.

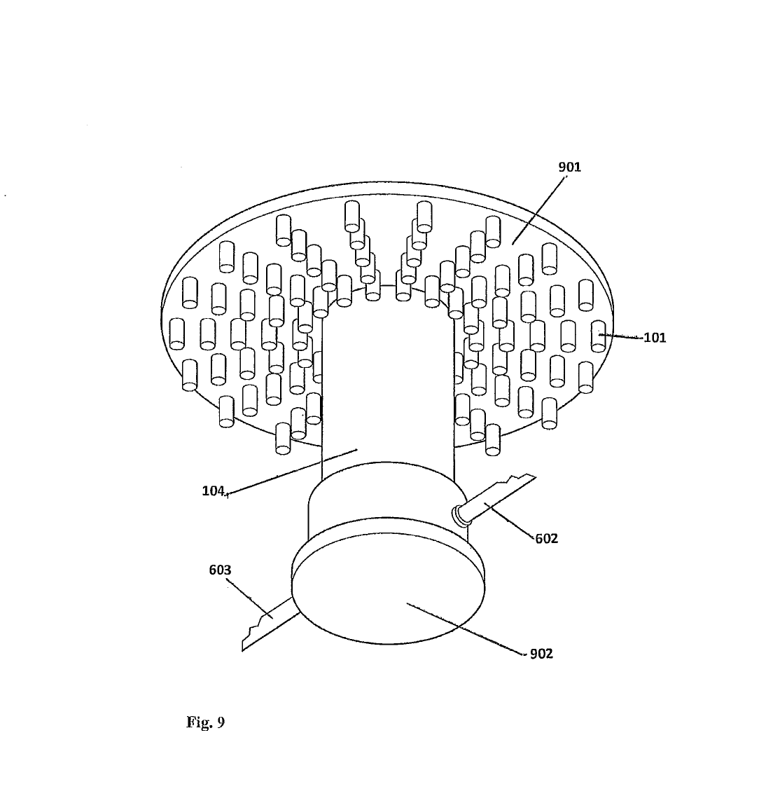

FIG. 9 shows an alternate embodiment where a plurality of ROM canisters 101 are in a vertical configuration relative to a buoyant cap 901. Pump 902 forces water from pressure vessel 104 through permeate line 602 and concentrate line 603.

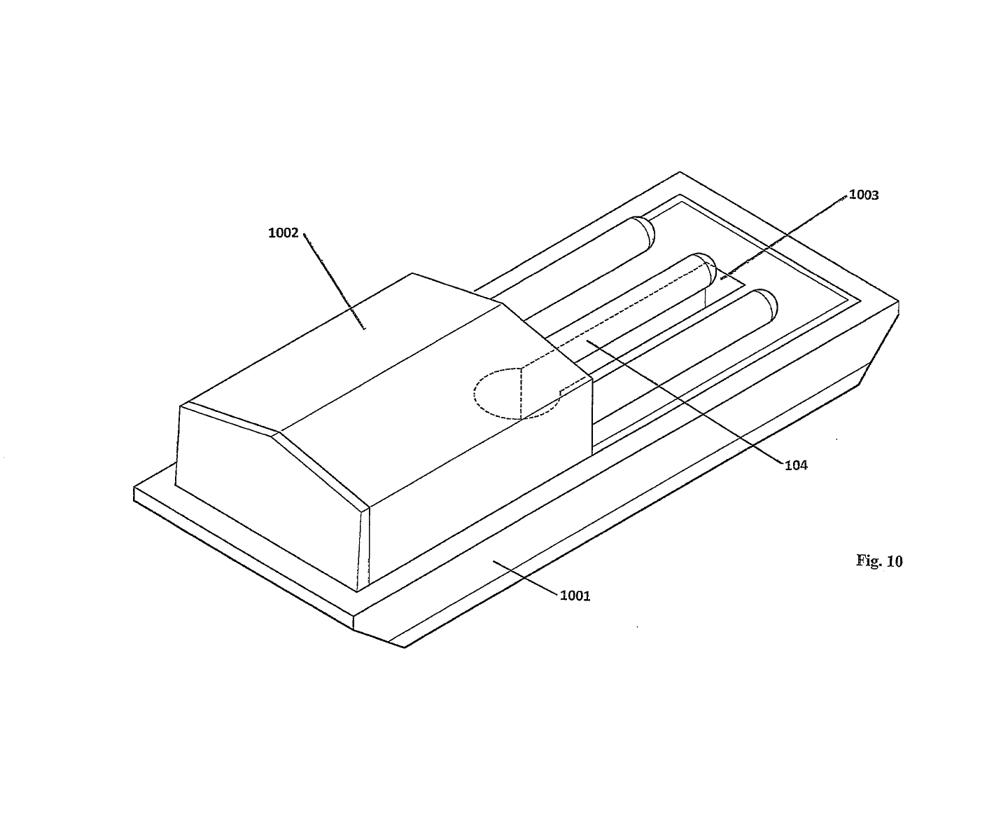

For siting and servicing, a specialized barge may be utilized which has an aperture is large enough to accommodate the pressure vessel with installed ROMs. FIG. 10 shows a barge 1001 with a partially retracted cover 1002. The aperture 1003 is ready to receive the pressure vessel 104 for descent. Additional assistive devices, such as a pressurized gas, could be placed alongside the vertical pressure vessel before it is lowered, with an appropriate valve and fittings.

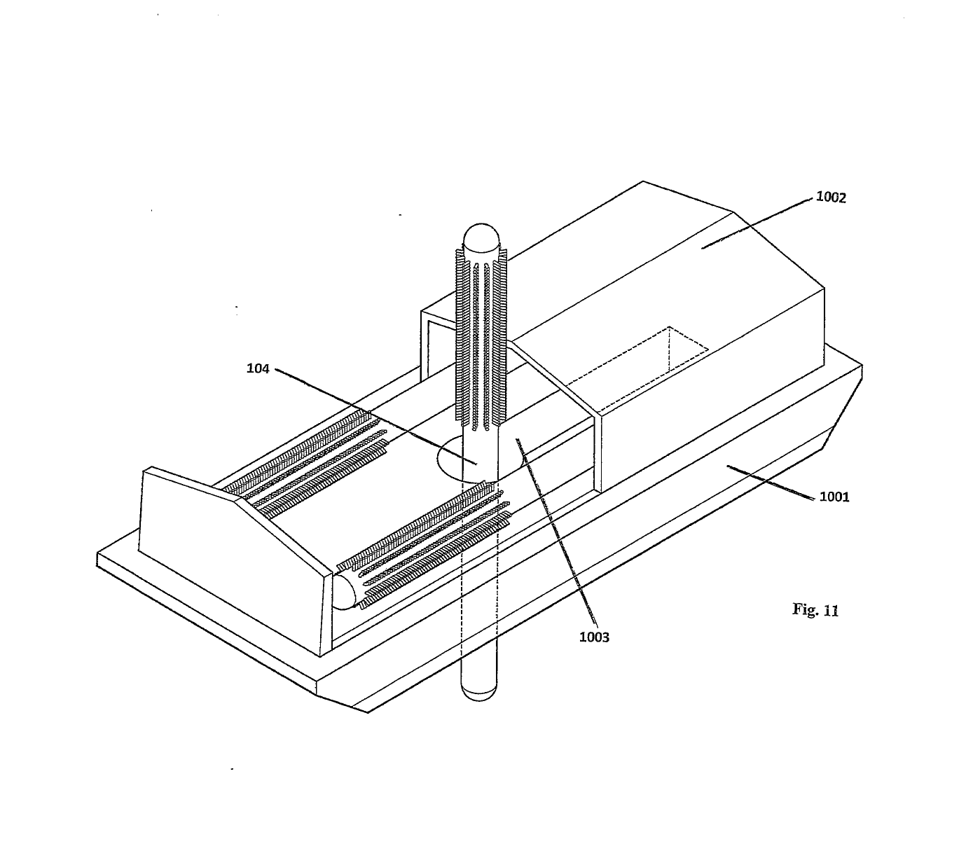

FIG. 11 shows the barge 1001 during ascent or descent of the pressure vessel 104. The cover 1002 has retracted. Aperture 1003 may have a keyhole configuration to accommodate pivoting of the pressure vessel with installed ROMs.

Other embodiments of the device may come in a variety of sizes with the same or similar form and function.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A filtration device, comprising
a) a pressure vessel having an interior and an exterior;
b) a reverse-osmosis membrane attached to said pressure vessel and separating the exterior from the interior; and
c) a pump, functionally connected to the interior, capable of removing a liquid from the interior of the pressure vessel.

2. The filtration device of claim 1, wherein the pressure vessel is capable of withstanding at least 4,000 kPa of pressure applied to said exterior.

3. The filtration device of claim 1, wherein the pump is capable of lowering an interior pressure to create a pressure differential sufficient to cause reverse osmosis to occur.

4. The filtration device of claim 1, wherein the pump is capable of pumping water from a predetermined depth below an upper surface of a body of water up to said surface.

5. The filtration device of claim 4, wherein said depth is at least 400 meters.

6. The filtration device of claim 1 wherein said pressure vessel has positive buoyancy when placed in seawater.

7. The filtration device of claim 6 further comprising an anchor of sufficient weight to overcome said buoyancy when attached to the device.

8. The filtration device of claim 7 further comprising
a) a tether connecting said anchor to said pressure vessel; and
b) a winch attached to said tether and capable of overcoming said buoyancy by pulling on the tether.

9. The filtration device of claim 1 further comprising a buoyant article connected to and capable of supporting the pressure vessel, membrane, and pump at a predetermined depth.

10. The filtration device of claim 9 wherein said buoyant article is further capable of supporting a winch, said winch being capable of overcoming the support of the buoyant article and pulling the device downward into a body of water.

11. The filtration device of claim 1 wherein said membrane is contained within a reverse-osmosis cartridge.

12. The filtration device of claim 11 comprising a plurality of said reverse-osmosis cartridges.

13. A method of desalination, comprising the steps of
a) providing a pressure vessel having an interior, an exterior, and reverse-osmosis membrane separating the exterior from the interior;
b) Providing a pump connected to said interior;
c) submerging the pressure vessel and membrane in a body of water to a depth sufficient to cause permeate to pass through the membrane and into the interior; and
d) pumping a quantity of the permeate out of the pressure vessel.

14. The method of claim 13, wherein the pressure vessel is submerged to a predetermined depth.

15. The method of claim 13, wherein said depth is at least 400 meters.

16. The method of claim 13 wherein the pressure vessel has positive buoyancy when placed in seawater.

17. The method of claim 16 comprising the steps of providing an anchor of sufficient weight to overcome said buoyancy and attaching said anchor to said pressure vessel.

18. The method of claim 17 comprising the steps of providing a tether attached to said anchor and winch capable of overcoming said buoyancy, and using the winch to submerge the pressure vessel by pulling on the tether.

19. The method of claim 10 comprising the step of pumping a quantity of said permeate to an upper surface of the body of water.

20. The method of claim 17 comprising the step vertically surfacing the pressure vessel through an aperture of a barge into the barge.
